(19) United States
(12) Patent Application Publication
(10) Pub. No.: US 2009/0268252 A1
(43) Pub. Date: Oct. 29, 2009

(54) IMAGE PROCESSING APPARATUS AND IMAGE PROCESSING METHOD

(75) Inventor: Hae-kee LEE, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/338,340

(22) Filed: Dec. 18, 2008

(30) Foreign Application Priority Data
Apr. 24, 2008 (KR) 2008-38408

(51) Int. Cl. H04N 1/405

(52) U.S. Cl. 358/3.06

(57) ABSTRACT

An image processing apparatus includes an image processor to perform halftoning with regard to an input image, and a controller which, if the input image is an output image printed through the halftoning, controls the image processor to perform the halftoning based on a second screen having a maximum angle difference from a first screen applied to the output image.

### CROSS-REFERENCE TO RELATED APPLICATIONS

This application claims priority under 35 U.S.C. §119(a) from Korean Patent Application No. 10-2008-0038408, filed on Apr. 24, 2008 in the Korean Intellectual Property Office, the disclosure of which is incorporated herein in its entirety by reference.

### BACKGROUND OF THE INVENTION

1. Field of the Invention

The present general inventive concept relates to an image processing apparatus and an image processing method, and more particularly, to an image processing apparatus and an image processing method which can perform halftoning with regard to a colorful or monochromatic image.

2. Description of the Related Art

An image processing apparatus such as a computer system, etc., processes a text, a photograph, a picture or an input image to be printed on paper or recording medium through a printing apparatus such as a printer, a multifunction peripheral, etc. The printing apparatus forms a plurality of dots corresponding to the input image by emitting (e.g., jetting) or fixing ink, a toner or the like on the recording medium on a basis of printing data obtained by processing the input image.

Here, the image processing apparatus converts the input image having a continuous tone into a printable halftone image so that the printing apparatus can determine where to jet and fix the ink, the toner or the like on the recording medium in order to form the dots, which is called halftoning.

Meanwhile, color halftoning often employs four screens of cyan (C), magenta (M), yellow (Y) and black (K), i.e., CMYK with regard to one image. Further, in the color halftoning, the four screens corresponding CMYK colors are inclined at predetermined angles, respectively, to thereby perform screening.

Because frequencies of the CMYK colors are overlapped under a condition that the four screens are inclined at the respective angles, an output image generates a noticeable repetitive pattern or noise called moire even though an original image does not have any repetitive pattern or noise.

Particularly, in the case of a generation copy that applies the halftoning again to the output image printed by applying the halftoning to the input image, more moire is caused.

### SUMMARY OF THE INVENTION

The present general inventive concept provides an image processing apparatus and an image processing method which can decrease moire even though a colorful or monochromatic image undergoes halftoning.

The present general inventive concept also provides an image processing apparatus and an image processing method which can decrease moire in consideration of previous halftoning in the case where the halftoning is performed again with regard to an output image printed by applying the halftoning to an input image.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept can be achieved by providing an image processing apparatus including an image processor to perform halftoning with regard to an input image, and a controller which, if the input image is an output image printed through the halftoning, controls the image processor to perform the halftoning based on a second screen having a maximum angle difference from a first screen applied to the output image.

If the input image may be colorful, the first screen and the second screen have the maximum angle difference with respect to one color.

The first screen and the second screen may be different in that two colors are interchanged among a plurality of colors.

The first screen and the second screen may have an angle difference of 45° in with respect to one color.

The first screen and the second screen each may include four screens corresponding to cyan (C), magenta (M), yellow (Y) and black (K).

The four screens each may include in the first and second screens correspond to angles of 27°, 45°, 63° and 90°, respectively.

The controller may perform the halftoning based on the first screen, and applies the halftoning based on the second screen to the output image printed through the halftoning.

The foregoing and/or other aspects and utilities of the present general inventive concept can also be achieved by providing an image processing method of performing halftoning with respect to an image, the method including receiving an input image, if the input image is an output image printed through the halftoning, performing the halftoning based on a second screen having a maximum angle difference from a first screen applied to the output image.

If the input image may be colorful, the first screen and the second screen have the maximum angle difference with respect to one color.

The first screen and the second screen may be different in that two colors are interchanged among a plurality of colors.

The first screen and the second screen have an angle difference of 45° in with respect to one color.

The first screen and the second screen each may include four screens corresponding to cyan (C), magenta (M), yellow (Y) and black (K).

The four screens each may include in the first and second screens correspond to angles of 27°, 45°, 63° and 90°, respectively.

The performing of the halftoning may include performing the halftoning based on the first screen, and applying the halftoning based on the second screen to the output image printed through the halftoning.

The foregoing and/or other aspects and utilities of the general inventive concept may also be achieved by providing an image processing apparatus including an image processor to perform halftoning to an input image, and a controller to control the image processor to perform the halftoning based on alternatively using a plurality of screens to reduce moire.

The moire may be reduced by performing a subsequent halftoning to the input image based on a consideration of a previous halftoning to the input image.

The foregoing and/or other aspects and utilities of the general inventive concept may also be achieved by providing a computer-readable recording medium having embodied thereon a computer program to execute a method, wherein the method including receiving an input image, if the input image is an output image printed through halftoning, performing the halftoning based on a second screen having a maximum angle difference from a first screen applied to the output image.

The foregoing and/or other aspects and utilities of the general inventive concept may also be achieved by providing an image processing apparatus including an image processor to receive an input image, and a controller to control the image processor to halftone data of the input image according to first and second screens of the input image.

The foregoing and/or other aspects and utilities of the general inventive concept may also be achieved by providing an image processing apparatus including an image processor to receive an input image, and a controller to control the image processor to determine whether the input image is a halftoned image, and to halftone data of the input image according to one of the first and second screen of the input image and the determination.

### BRIEF DESCRIPTION OF THE DRAWINGS

The above and/or other aspects of the present general inventive concept will become apparent and more readily appreciated from the following description of the exemplary embodiments, taken in conjunction with the accompanying drawings, in which:

FIG. 1 is a block diagram illustrating an image processing apparatus according to an embodiment of the present general inventive concept;

FIG. 2 illustrates a first screen and a second screen according to an embodiment of the present general inventive concept;

FIGS. 3 through 5 illustrate output images according to an embodiment of the present general inventive concept;

FIG. 6 illustrates a first screen and a second screen according to another embodiment of the present general inventive concept; and

FIGS. 7 and 8 are flowcharts illustrating an image processing method according to an embodiment of the present general inventive concept.

### DETAILED DESCRIPTION OF THE PREFERRED EMBODIMENTS

Reference will now be made in detail to embodiments of the present general inventive concept, examples of which are illustrated in the accompanying drawings, wherein like reference numerals refer to the like elements throughout. The embodiments are described below in order to explain the present general inventive concept by referring to the figures.

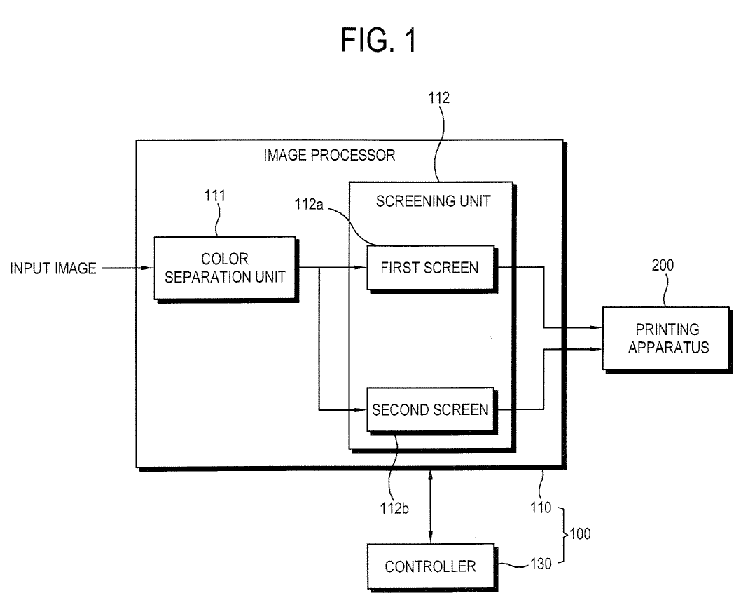

FIG. 1 is a block diagram illustrating an image processing apparatus 100 according to an embodiment of the present general inventive concept. The image processing apparatus 100 processes a text, a photograph, a picture, or an input image to be printed on paper or recording medium through a printing apparatus 200. In this embodiment, the image processing apparatus 100 may be achieved by a computer system, etc.

The printing apparatus 200 forms a plurality of dots corresponding to the input image by jetting or fixing an ink, a toner or the like on the recording medium on a basis of printing data obtained by processing the input image. In this embodiment, the printing apparatus 200 may be achieved by a printer, a multifunction peripheral, etc., and employ an inkjet method, a laser method, etc., to form an image on a printing medium. The printing apparatus may include a feeding unit to feed the printing medium, a printing unit to print the image according to the input image, and discharge unit to discharge the printing medium with the image.

The image processing apparatus 100 converts the input image having a continuous tone into a printable halftone image so that the printing apparatus can determine where to jet and fix the ink, the toner or the like on the recording medium in order to form the dots. The image processing apparatus 100 simulates shades of gray or colors in the input image through varying amplitudes of the dot in the halftone image. That is, the image processing apparatus 100 performs halftoning to convert the input image into the halftone image according to screening methods.

In this embodiment, the image processing apparatus 100 and the printing apparatus 200 are provided independently of each other, but not limited thereto. As necessary, the printing apparatus 200 may include an image processor 110 to perform the halftoning without the image processing apparatus 100, so that the image can be processed and formed by only the printing apparatus 200.

As illustrated in FIG. 1, the image forming apparatus 100 according to an embodiment of the present general inventive concept includes an image processor 110, and a controller 120. The image processor 110 includes a color separation unit 111 and a screening unit 112.

The color separation unit 111 separates an input colorful image into a plurality of intermediate images corresponding to colors. In this embodiment, the color separation unit 110 separates the input colorful image into four color planes for the intermediate images corresponding to cyan (C), magenta (M), yellow (Y) and black (K).

The screening unit 112 performs screening (or halftoning) with regard to four intermediate images separated by the color separation unit 110. Here, the screening unit 112 may include a first screen 112a and a second screen 112b.

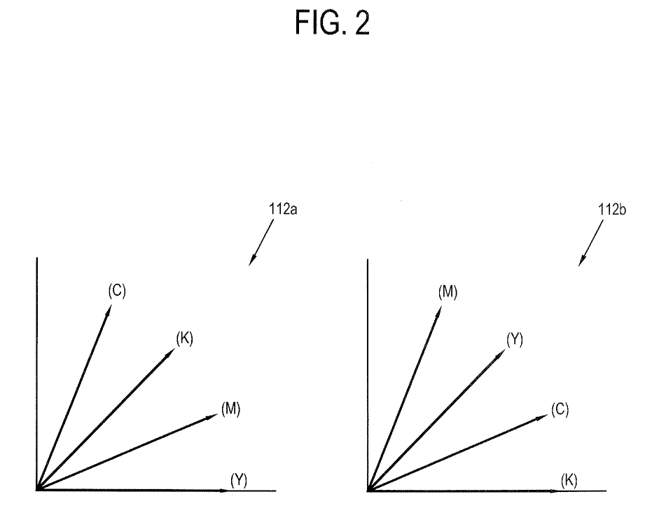

The first screen 112a and the second screen 112b are tables each having a plurality of cells. As illustrated in FIG. 2, the first screen 112a and the second screen 112b may each include four screens inclined at predetermined angles corresponding to CMYK colors. Here, the four screens may be inclined at 0°, 27°, 45° and 63° (or 27°, 45°, 63° and 90°).

In this embodiment, a maximum angle difference between the first screen 112a and the second screen 112b is set with regard to the same color among the plurality of colors.

For example, as illustrated in FIG. 2, if the first screen 112a has Cyan of 63°, Black of 45°, Magenta of 27° and Yellow of 0°, the second screen 112b may have Cyan of 27°, Black of 0°, Magenta of 63° and Yellow of 45°. That is, the first screen 112a and the second screen 112b are different in 45° with respect to the same color.

The controller 130 controls the color separation unit 111 to separate the colorful input image into the plurality of intermediate images corresponding to the plurality of colors, and the screening unit 112 to perform the halftoning based on either of the first screen 112a or the second screen 113a with regard to the plurality of intermediate images. When applying the halftoning to the input image, the controller 130 reads information from the first and second screens 112a and 113a previously stored or programmed, and controls the image processor 110 to perform the halftoning on a basis of the read information.

If the input colorful image is a printed output image that underwent the halftoning, the controller 130 controls the screening unit 112 to perform the halftoning on a basis of a new screen having the maximum angle difference from the screen previously applied to the output image with respect to the same color.

For instance, if the input image is the output image that underwent the halftoning based on the first screen 112a of FIG. 2, the controller 130 performs the halftoning on a basis of the second screen 112b of FIG. 2, which has the maximum angle difference from the first screen 112a with regard to the same color, when applying the halftoning again to the output image.

Here, the second screen 112b may result from interchanging two colors among the plural colors of the first screen 112a. Referring to FIG. 2, the second screen 112b is obtained by interchanging cyan with magenta and interchanging black with yellow in the first screen 112.

Referring to FIG. 2, the first screen 112a and the screen 112b differ from each other in an inclined angle by 45° with respect to the same color.

According to an embodiment of the present general inventive concept, in the case of a generation copy that needs the halftoning two or more times in one printing apparatus 200, varying screens may be applied to the plural times of halftoning.

Specifically, the controller 130 separates the input image into a plurality of intermediate images (color planes) corresponding to a plurality of colors through the color separation unit 111, and controls the screening unit 112 to apply first halftoning based on the first screen 112a to the plurality of intermediate images.

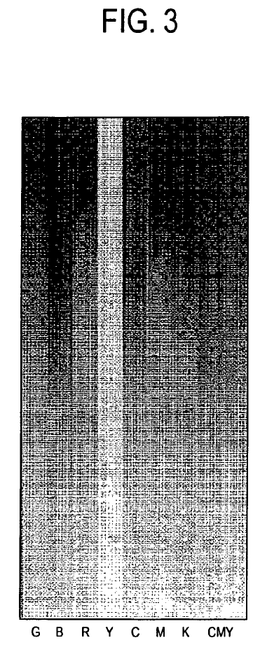

FIG. 3 illustrates a first output image that underwent a first halftoning.

Then, the controller 130 controls the screening unit 112 to apply second halftoning based on the second screen 112b to the first output image.

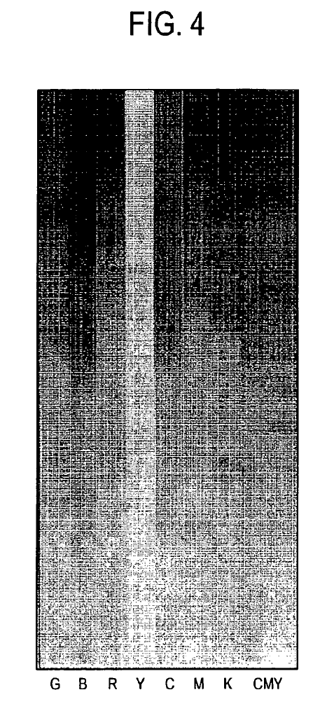

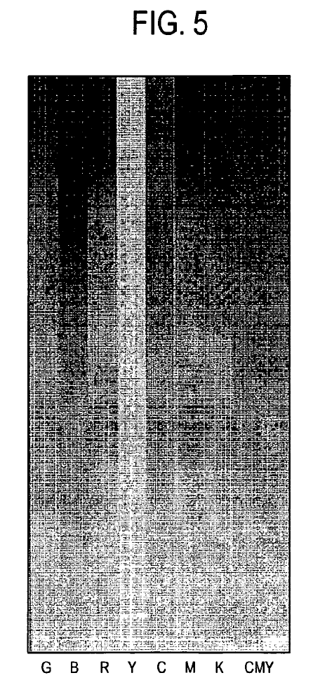

FIGS. 4 and 5 illustrate second output images that underwent a second halftoning, in which FIG. 4 is a result from the second halftoning based on the first screen 112a, and FIG. 5 is a result from the second halftoning based on the second screen 112b.

The second output image of FIG. 4, which underwent the second halftoning based on the same first screen 112a as the first halftoning, has a noticeable repetitive pattern or noise, i.e., moire more than that of FIG. 5, which underwent the second halftoning based on the second screen 112b.

Further, if the halftoning is applied again to the second output image, the controller 130 may control the image processor 110 to perform the halftoning based on the first screen 112a. Thus, the two screens are alternately used in performing the halftoning, so that moire can be reduced as compared with that generated when using one screen.

In addition to processing the foregoing generation copy, the image processing apparatus 100 may be configured to determine whether the input image is the output image that underwent the halftoning through a user's selection or a predetermined algorithm, and perform the halftoning based on one of the plural screens according to determination results.

According to another embodiment of the present general inventive concept, the image processing apparatus 100 may process a monochromatic image as well as a colorful image.

In the case where the image processing apparatus 100 performs the halftoning with regard to the monochromatic image, the controller 130 controls the screening unit 112 to apply the halftoning based on either of the first screen 112a or the second screen 112b to a monochromatic input image. That is, if the input image is monochromatic, a color separation needed for the colorful image may be omitted.

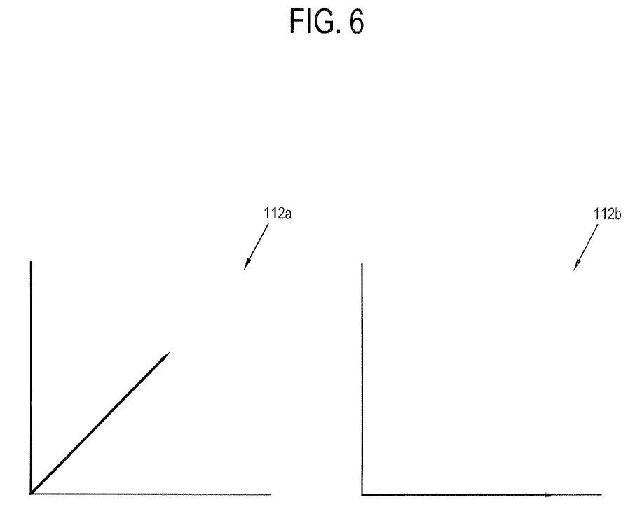

Here, the first screen 112a and the second screen 112b are tables each having a plurality of cells. As illustrated in FIG. 6, the first screen 112a and the second screen 112b may each include one screen inclined at a predetermined angle. Here, each screen may be inclined at 0° or 45°.

In the image processing apparatus 100 according to this embodiment, the first screen 112a and the second screen 112b may be set to have the maximum angle difference therebetween. For example, referring to FIG. 6, the first screen 112a and the second screen 112b are inclined at the angles of 0° or 45°, respectively. That is, the angle difference between the first screen 112a and the second screen 112b may be 45°.

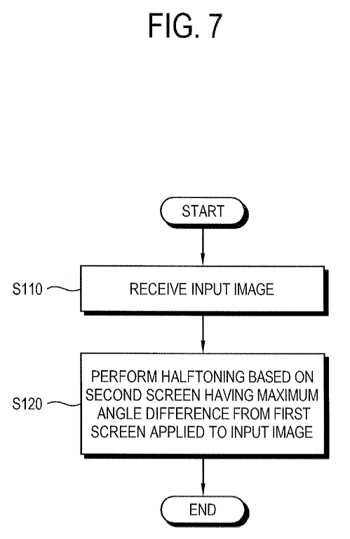

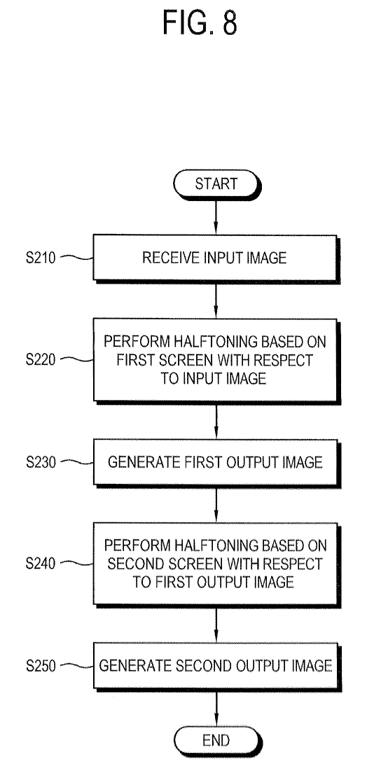

In the image processing apparatus 100 with the above configuration, a control method thereof will be described with reference to FIGS. 7 and 8.

As illustrated in FIG. 7, the image processing apparatus 100 receives an input image (operation S110).

If the input image is an image that underwent the halftoning, the controller 130 performs the halftoning based on the second screen 112b having the maximum angle difference from the first screen 112a applied to the input image (operation S120). Here, if the input image is colorful, the first screen 112a and the second screen 112b each have four screens corresponding to cyan (C), magenta (M), yellow (Y) and black (K). In this case, the four screens may be inclined at angles of 27°, 45°, 63° and 90°. Alternatively, if the input image is monochromatic, the first screen 112a and the second screen 112b each have one screen having a predetermined angle. In this case, the respective screens may be inclined at angles of 45° and 90°.

Meanwhile, when a user selects the generation copy, the image processing apparatus 100 may control the image processor 110 to sequentially perform the plural times of halftoning with respect to the input image.

Referring to FIG. 8, the image processing apparatus 100 receives an input image (operation S210).

The controller 130 performs the halftoning based on the first screen 112a with respect to the input image (operation S220).

Further, the controller 130 generates the first output image that underwent the halftoning at the stage S220 (operation S230).

Then, the controller 130 performs the halftoning based on the second screen 112b with regard to the first output image (operation S240). In the case of a colorful image, the second screen 112b has the maximum angle difference from the first screen 112a with respect to the same color. That is, the second screen 112b may result from interchanging two colors among the plural colors corresponding to C, M, Y and K of the first screen 112a, and the first screen 112a and the second screen 112b may differ from each other in an inclined angle by 45° with respect to the same color. Alternatively, in the case of a monochromatic image, the first screen 112a has the maximum angle difference from the second screen 112b, and the maximum angle difference may be 45°.

Further, the controller 130 generates the second output image that underwent the halftoning at the stage S230 (operation S250).

Meanwhile, if the halftoning is applied again to the second output image generated at the stage S250, the controller 130 may control the image processor 110 to perform the halftoning based on the first screen 112a.

The present general inventive concept can also be embodied as computer-readable codes on a computer-readable medium. The computer-readable medium can include a computer-readable recording medium and a computer-readable transmission medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

As described above, the present general inventive concept provides an image processing apparatus and an image processing method which can decrease moire even though a color or monochromatic image undergoes halftoning.

Particularly, in the case where the halftoning is performed again with regard to an output image printed by applying the halftoning to an input image, moire is more effectively decreased as the previous halftoning is considered.

Although various exemplary embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. An image processing apparatus, comprising:
an image processor to perform halftoning with regard to an input image; and
a controller which, if the input image is an output image printed through the halftoning, controls the image processor to perform the halftoning based on a second screen having a maximum angle difference from a first screen applied to the output image.

2. The image processing apparatus according to claim 1, wherein if the input image is colorful, the first screen and the second screen have the maximum angle difference with respect to one color.

3. The image processing apparatus according to claim 2, wherein the first screen and the second screen are different in that two colors are interchanged among a plurality of colors.

4. The image processing apparatus according to claim 2, wherein the first screen and the second screen have an angle difference of 45° in with respect to one color.

5. The image processing apparatus according to claim 2, the first screen and the second screen each comprise:
four screens corresponding to cyan (C), magenta (M), yellow (Y) and black (K).

6. The image processing apparatus according to claim 5, wherein the four screens each included in the first and second screens correspond to angles of 27°, 45°, 63° and 90°, respectively.

7. The image processing apparatus according to claim 1, wherein the controller performs the halftoning based on the first screen, and applies the halftoning based on the second screen to the output image printed through the halftoning.

8. An image processing method of performing halftoning with respect to an image, the method comprising:
receiving an input image;
if the input image is an output image printed through the halftoning, performing the halftoning based on a second screen having a maximum angle difference from a first screen applied to the output image.

9. The image processing method according to claim 8, wherein if the input image is colorful, the first screen and the second screen have the maximum angle difference with respect to one color.

10. The image processing method according to claim 9, wherein the first screen and the second screen are different in that two colors are interchanged among a plurality of colors.

11. The image processing method according to claim 9, wherein the first screen and the second screen have an angle difference of 45° in with respect to one color.

12. The image processing method according to claim 9, the first screen and the second screen each comprise:
four screens corresponding to cyan (C), magenta (M), yellow (Y) and black (K).

13. The image processing method according to claim 12, wherein the four screens each included in the first and second screens correspond to angles of 27°, 45°, 63° and 90°, respectively.

14. The image processing method according to claim 8, wherein the performing of the halftoning comprises:
performing the halftoning based on the first screen; and
applying the halftoning based on the second screen to the output image printed through the halftoning.

15. An image processing apparatus, comprising:
an image processor to perform halftoning to an input image; and
a controller to control the image processor to perform the halftoning based on alternatively using a plurality of screens to reduce moire.

16. The apparatus according to claim 15, wherein the moire is reduced by performing a subsequent halftoning to the input image based on a consideration of a previous halftoning to the input image.

17. A computer-readable recording medium having embodied thereon a computer program to execute a method, wherein the method comprises:
receiving an input image;
if the input image is an output image printed through halftoning, performing the halftoning based on a second screen having a maximum angle difference from a first screen applied to the output image.
